(19) United States
(12) Patent Application Publication
(10) Pub. No.: US 2008/0054670 A1
(43) Pub. Date: Mar. 6, 2008

(54) VISOR CLIP

(76) Inventors: Vickie Lee Foster, Berkley, MI (US); Laura Lee Reutter, Pinckney, MI (US)

Correspondence Address: YOUNG & BASILE, P.C., 3001 WEST BIG BEAVER ROAD, SUITE 624, TROY, MI, 48084, US

(21) Appl. No.: 11/774,653

(22) Filed: Jul. 9, 2007

Related U.S. Application Data
(60) Provisional application No. 60/830,578, filed on Jul. 14, 2006.

(51) Int. Cl. B60R 7/05

(52) U.S. Cl. 296/97.9

(57) ABSTRACT

A vehicle visor clip for attaching articles to an edge of a vehicle visor includes a clip body of moveable side legs joined to an end wall. Handles are affixed to the free ends of each side leg and fixedly attached to the side legs. A pad is joined to the ends of the handle legs such that pressure moving the pads toward each other causes the free ends of the side legs of the clip body to separate to mount or remove the clip relative to the visor or to insert or remove articles between one side leg of the clip and the visor. The handle and clip body and pad may be encapsulated in a resilient material to fixedly join the handle legs to the clip body. Alternatively, the ends of the handles may be formed in a decorative shape.

### CROSS REFERENCE TO CO-PENDING APPLICATION

This application claims priority benefit to the filing date of co-pending U.S. Provisional Application Ser. No. 60/830,578, filed Jul. 14, 2006 in the names of Vickie Lee Foster and Laura Lee Reutter, and entitled “Motorcycle Windshield Map and Picture Holder,” the entire contents of which are incorporated herein.

### BACKGROUND

The present invention relates, in general, to clips and, more particularly, to vehicle visor clips for attaching articles, such as maps, to the vehicle visor.

Clips for attaching articles to a surface or to other articles or merely to retain the articles together in a stack are widely used in many applications. Close pin type clips are known which have two legs hingedly connected at a center such that urging one pair of spaced ends of the legs together opens the opposite ends of the legs, and vice versa.

So called binder clips are used to hold large numbers of loose papers in a bundle or stack. The substantially U-shaped body of the binder clip is made of spring material. Two legs extend angularly inward toward each other from an opposed closed end to form freely movable ends. Two hoop-like handles are pivotally attached to the first free ends of each of the legs and are movable from a first position extending from the first ends to overlay the papers or articles secured by the clip, to a second position overlaying the side legs of the clip. In this position, the ends of the handles extend beyond the end wall. Pressing the ends of the handles together opens the free ends of the side legs to allow relative movement between the clip and the loose articles or papers.

It is known to employ slide on caps with such binder clips which slide over the handle ends to smooth the enlarged surfaces of the wire-like ends to facilitate easy use, to catalog the joined articles by color, letters, numbers, etc., placed on the caps, or to form a surface for advertising.

What is needed is a clip for vehicle visors, such as motorcycle or snowmobile visors, for attaching papers, such as a map, directions, photos, etc., to the visor. It would be desirable to provide such a clip which is easy to use, is aesthetically pleasing when mounted on the visor, enables the driver of the vehicle to read the map or text on the papers without substantially looking away from the visor, is capable of one handed operation, and is customizable with a club logo or other promotional indicia.

### SUMMARY

A clip mountable on a surface includes a body having an end wall and opposed first and second side legs extending from the end wall to respective first and second freely movable ends. First and second handles are respectively mounted to the first and second free ends of the first and second side legs of the body. The first and second legs have free ends attached to a pad. The first and second handle legs are fixedly attached to the first and second side legs of the clip body.

A decorative plate is mounted on the exterior surface of the pad. The clip body, the first and second handle legs and the pad are encapsulated in a cover material which fixedly joins the handle legs to the clip body. The encapsulating material can be a resilient material. The pad is fixedly joined to the ends of the handle legs and to the clip wherein the pad is over moldingly joined to the handle legs. The first and second handles may be formed in a decorative shape.

The visor clip disclosed herein provides numerous unique features not found in previously devised clips. The disclosed visor clip is easy to use, particularly in a one hand operation for mounting on or removing the clip with respect to the visor or inserting or removing articles between the clip and the visor. The visor clip also has an aesthetically pleasing appearance when mounted on the vehicle visor. The visor clip also enables the vehicle driver to read the maps or papers or look at photographs mounted on the visor by the clip without substantially moving his or her eyes from the moving direction of the vehicle through the visor. The visor clip may also be customizable with motorcycle club logos, and other promotional materials or simply have a decorative shape.

### BRIEF DESCRIPTION OF THE DRAWING

The various features, advantages and other uses of the disclosed visor clip will become more apparent by referring to the following detailed description and drawing in which.

FIG. 1 is a perspective view of one aspect of a visor clip;

FIG. 2 is a cross sectional view showing a molding operation used in the manufacture of clip shown in FIG. 1;

FIG. 3 is a partial, enlarged view of a portion of the clip shown in FIGS. 1 and 2, prior to insertion in the mold depicted in FIG. 2;

FIG. 4 is a prospective view showing the visor clips of FIGS. 1-3 mounted on a visor;

FIG. 5 is a perspective view of another aspect of the visor;

FIG. 6 is a side elevational view of another aspect of a vehicle visor;

FIG. 7 is an end view of the clip shown in FIG. 6;

FIG. 8 is a side view of another aspect of a visor; and

FIG. 9 is a side view of another aspect of a visor clip.

### DETAILED DESCRIPTION

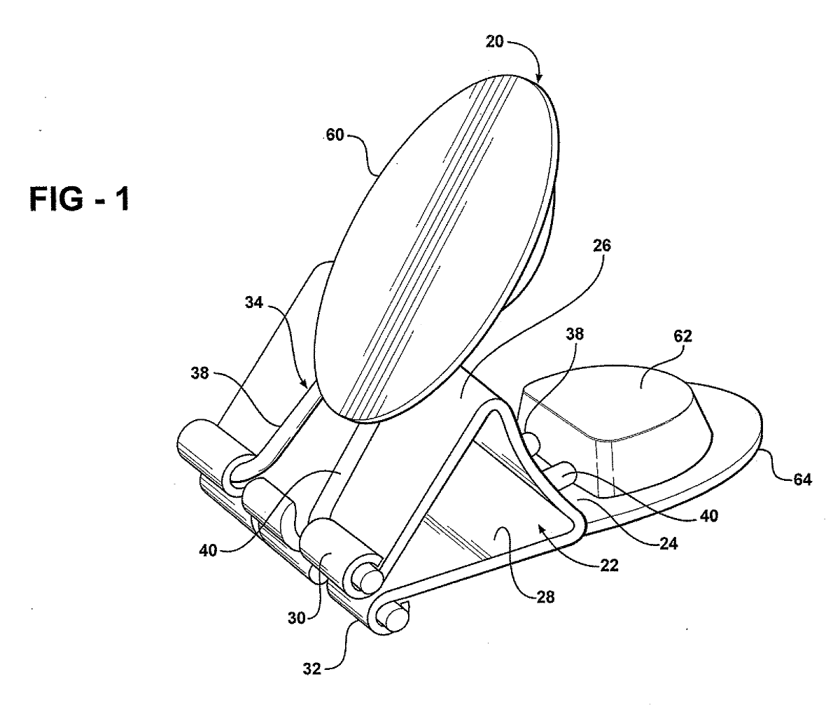

Referring now to FIGS. 1-4, there is depicted one aspect of a clip 20 which is suitable for mounting on motor vehicle visors, such as visors of motorcycles, snowmobiles, etc., to retain paper-type articles, such as maps, photographs, directions printed on paper, etc., on one edge of the visor.

As shown in FIGS. 1-4, the visor clip 20 includes a clip body 22 having an end wall 24 from which first and second side legs 26 and 28, respectively, extend from a first end contiguous with the end wall 24 to an opposed free end 30 and 32, respectively.

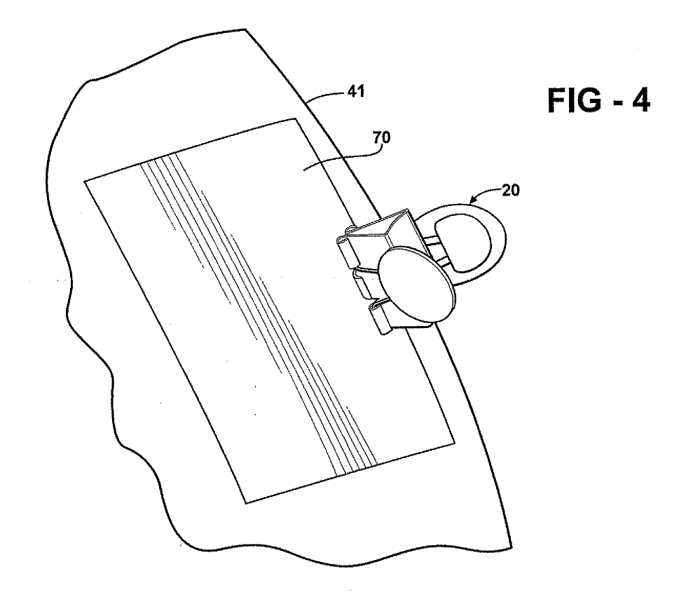

The clip body 22 is formed of a spring material, such as a spring plastic or a spring metal. In a natural, relaxed state, as shown in FIG. 1, the side legs 26 and 28 extend angularly inward toward each other such that the free ends 30 and 32 are disposed in close proximity or actually touching. Due to the resilient or elastic nature of the material forming the body 22, the free ends 30 and 32 may be urged away from each other to allow the insertion of or the removal of articles into and out of the interior of the body 22 between the side legs 26 and 28 and the end wall 32, as well as to mount the body 22 on the edge of a vehicle visor 40 as shown in FIG. 4 and described in greater detail thereafter.

First and second handles 34 and 36 may be substantially identically formed of a wire loop with first and second legs 38 and 40 illustrated by example only, for the first handle 34. Each of the legs 38 and 40 terminates in an angularly outward, bent flange, not shown, which moveably fits within openings formed in the folded over first free end 30 of the side leg 26.

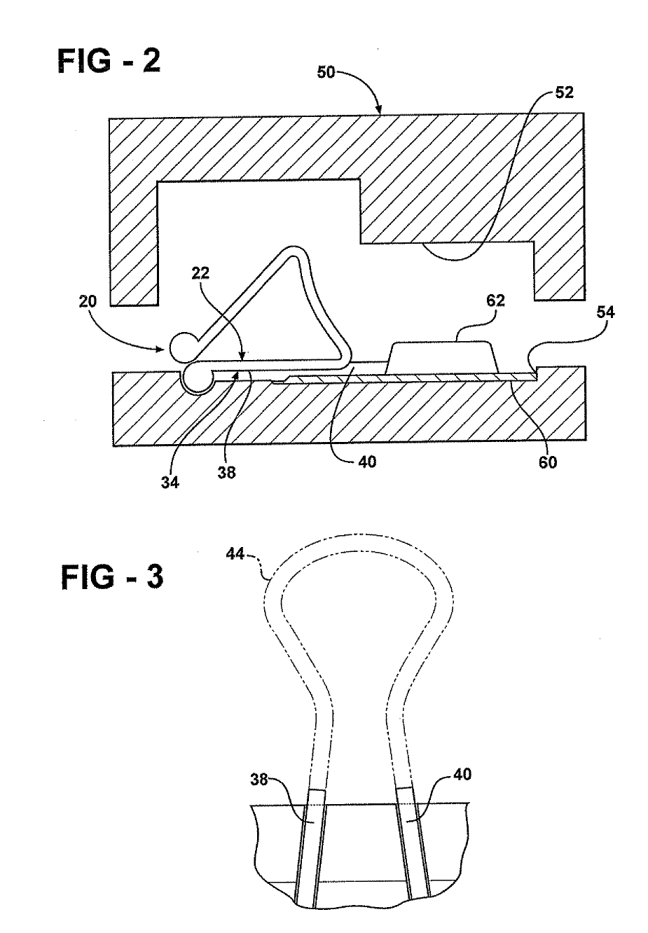

The second handle 36 is similarly normally pivotally connected to the folded over second free end 32 of the side leg 28. As shown in the phantom lines in FIG. 3 and depicted by reference number 44, the closed end of the loop 44 is cut off leaving the two legs 38 and 40 separate from each other and disposed in an overlaying arrangement with respect to the respective side leg 26 and 28 as shown in FIGS. 1 and 2.

By way of example only, the thus formed clip body 22 with the cut handle legs 38 and 40 is disposed in a mold 50 formed of first and second mold halves each having an appropriately formed mold surface 52 and 54 which, when in a closed position, allows for the injection of a molten resin or plastic material into the open portions between the mold surfaces.

A pad 60 having any peripheral shape, such as oval, square, rectangular, etc., is disposed within the mold cavity 54 and has a portion disposed adjacent to and juxtaposed with the ends of the cut ends of the legs 38 and 40. When the mold 50 is closed and molten plastic or resin injected through screws or runners, not shown, into the open interior of the mold cavity 52 and 54, a pad 62, shown in FIG. 1, is formed on one side of and around the edges of the pad 64. At the same time, the molten plastic or resin covers all of the exposed surfaces of the clip body 22 and the cut legs 38 and 40 of the handles 34 and 36 thereby fixing the pivotal legs 38 and 40 of each handle 34 and 36 onto the respective side legs 26 and 28.

As shown in FIG. 1, with the handle legs 38 and 40 fixed and covered by the plastic or resin to the clip body 22, the pad 60 attached to each handle 34 and 36 projects away from the end wall 24 of the clip body 22. Finger pressure on the outer ends of the pad 60 will cause the free ends 30 and 32 of the side legs 26 and 28 of the clip 22 to move apart to allow the clip 20 to be mounted on the edge of a visor 40 as shown in FIG. 4. At the same time, sheet material 70, such as a map, printed directions, photograph, etc., may be interposed between the side leg 26 and the visor 40 to retain the article 70 in an easily visible position to the vehicle driver of the vehicle. In this position, the vehicle driver may read the map or written directions or view a photograph mounted on the visor 40 by the clip 20 without substantially diverting his or her eyes from the direction in which the vehicle is moving or through the visor.

At the same time, the clip 20 may be easily removed or the free ends 30 and 32 separated to allow the removal of the article 70 from the clip 20 and the visor 40 or the insertion of additional articles in front of or behind the article 70 already mounted on the visor 40 by the clip 20.

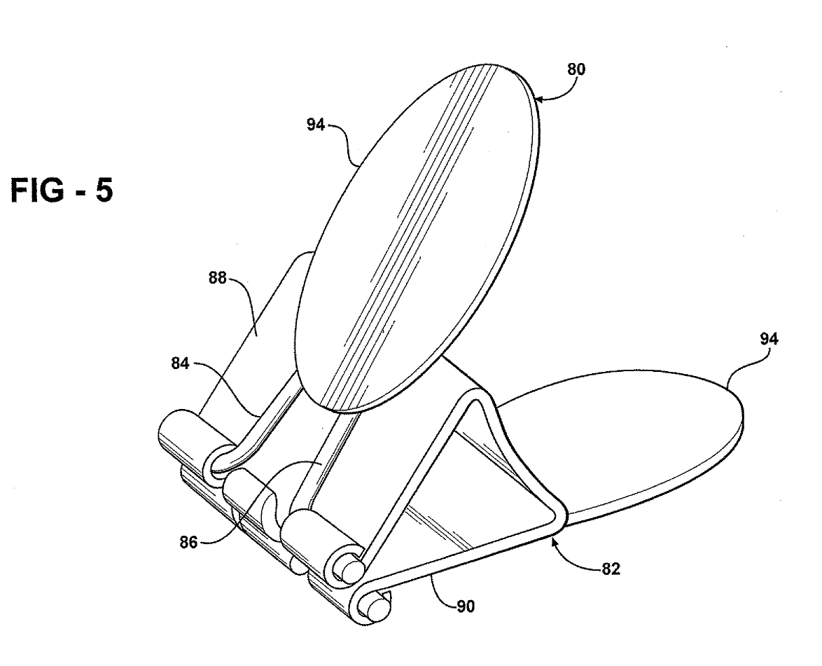

Referring now to FIG. 5, there is depicted another aspect of a clip 80 which has a clip body 82 substantially identical to the clip body 22 shown in FIG. 1. In this aspect, the legs 84 and 86 of each wire-like loop shaped handle are cut, but at a position between the opposed ends of the clip body side legs 88 and 90. The free ends of the legs 84 and 86 of each handle are fixedly joined to a disc-like plate 94 by welding, adhesive, or by immersing the entire clip body and pads 94 and 96 into a plastic or resin bath so that the entire clip 80 including the pads 94 are encapsulated within a coating of plastic or resin. A decorative plate may be then adhesively or otherwise fixedly secured to the outer surfaces of the pad 94 for advertising, etc.

Referring now to FIG. 6-9, there depicted other aspects of a visor clip in which each clip includes a clip body 22 substantially as described above. In each aspect, however, the typical loop-like handles are formed in a decorative manner such as the motorcycle and rider handles 100 shown in FIGS. 6 and 7, a promotional logo shape 102 shown in FIG. 8 or a simple decorative shape, such as flames 104 in FIG. 9, by way of example only. As also shown in FIG. 9, the side edges 106 and 108 of the side legs of the clip body 22, instead of having generally straight parallel edges, may also be formed in a decorative shape, consistent with or completely disparate from the shape of the handles 104. By way of example only, the side edges 106 are formed with a flame shape consistent with the flame shaped handles 104.

What is claimed is:

1. A clip mountable on a surface comprising:
a body having an end wall and opposed first and second side legs extending from the end wall to respective first and second free ends;
first and second handles respectively mounted to the first and second free ends of the first and second side legs of the body; and
the first and second legs having free ends attached to a pad.

2. The clip of claim 1 wherein the first and second handle legs are fixedly attached to the first and second side legs of the clip body.

3. The clip of claim 1 wherein a decorative plate is mounted on the exterior surface of the pad.

4. The clip of claim 1 further comprising:
the clip body, the first and second handle legs and the pad encapsulated in a cover material, the cover material fixedly joining the first and second handle legs to the clip body.

5. The clip of claim 4 wherein the encapsulating material is a resilient material.

6. The clip of claim 1 wherein the pad is fixedly joined to the ends of the handle legs.

7. The clip of claim 6 wherein the pad is over moldingly joined to the handle legs.

8. The clip of claim 1 wherein:
the first and second handles are formed in a decorative shape.
